(19) United States
(12) Patent Application Publication
(10) Pub. No.: US 2003/0159837 A1
(43) Pub. Date: Aug. 28, 2003

(54) Multipurpose water hammer with a penetrating nozzle

(76) Inventor: Theodore Thomas Itschner, Norfolk, VA (US)

Correspondence Address: Bradley D. Goldizen, 192 Ballard Ct., Suite 400, Virginia Beach, VA, 23462, US

(21) Appl. No.: 10/082,713

(22) Filed: Feb. 25, 2002

(51) Int. Cl. A62C 2/00

(52) U.S. Cl. 169/70; 239/271

(57) ABSTRACT

The invention includes a piercing nozzle for penetrating fire barriers such as building materials or car hoods. The piercing nozzle affixes to an end of a center pipe that attaches to a handle. In one embodiment of the invention, a hammer end is provided on the center pipe. A fire fighter may swing the invention in an axe-like manner to cause the piercing nozzle to penetrate a fire barrier. Alternatively, the fire fighter may use a sledgehammer or similar tool to drive the piercing nozzle through the fire barrier.

There are no related patent applications.

The patent application was not subject to federally funded research or development.

### BACKGROUND OF THE INVENTION

The present invention generally relates to fire fighting equipment. More particularly, the present invention relates to a hammer-type device equipped with a piercing nozzle for penetrating a fire barrier and delivering water or other fire extinguishing materials to an enclosed area having a fire therein.

Many fire departments respond to fires that are burning in automobiles. Typically, the fire is caused by a malfunction in the engine compartment of the automobile. In order to deliver water or foam to the burning engine, the hood must be raised.

A hood release is a device that typically includes a latch for securing the hood to close the engine compartment. A lever located in the passenger compartment actuates the latch via a cable. In many automobile fires, the cable coupling the lever to the latch or the latch itself melts, thereby preventing firefighters from readily accessing the engine compartment and dousing the fire.

The present invention allows firemen to deliver water, foam or other fire extinguishing fluids readily to the engine compartment of an automobile. The invention may also be advantageously used to penetrate fire barriers in buildings and the like.

U.S. Pat. No. 4,802,535 to Bakke discloses a fire-fighting tool with a hardened conical point at one end thereof and having a hollow interior. A rear end portion of the tool is provided with two pairs of handles. A connector coupling is adapted to connect the hollow interior with a fire hose.

The forward and hollow end portion of the tool is frusto-conically shaped and is perforated to deliver water. Perforations toward the forward-most region of the perforated portion of the tool are directed forwardly; while perforations in the rearward-most region are directed rearwardly. The perforations in the rearward-most region generate a force that will maintain the tool in a position while unattended.

The Bakke fire-fighting tool is bulking and cannot be efficiently used when fighting fire in engine compartments of automobiles. Use of a Bakke fire-fighting tool during a car fire requires the firemen to pierce through a side of the automobile such a front quarter panel. Otherwise, the firefighters must be positioned at a significantly higher elevation that that of the automobile hood to properly use the device.

U.S. Pat. No. 5,649,599 to Catanese, Jr. discloses a fast attack penetrating nozzle for minimizing potential formation of backdraft conditions during fire suppression operations. In Catanese, a protector tip on a nozzle is driven through barriers of standard building materials. Pressurized water causes the protector tip to be forced from the nozzle during fire fighting operations. However, the Catanese device cannot be driven through a fire barrier and left unattended during operations. If the Catanese device is left unattended, the inherent pressure transmitted through the nozzle by pressurized water emitting therethrough, will cause the device to be ejected rearwardly, and to thrash about much like the free end of a garden hose when water under substantial pressure is transmitted therethrough.

The present invention comprises a piercing nozzle that can be driven or forced through building materials or the hood of an automobile to deliver pressurized water thereto. The invention includes a means and method for maintaining the tool in a position while left unattended.

### BRIEF SUMMARY OF THE INVENTION

Accordingly, it is an object of the present invention to provide a piercing nozzle that can readily pierce a fire barrier without the need for other devices such as sledgehammers or axes.

It is another object of the invention to provide a piercing nozzle that can be driven into and through a fire barrier during fire fighting operations with the aid of sledgehammers or axes.

It is a further object of the invention to provide a piercing nozzle that can be readily driven through the hood of a car to quickly extinguish a fire in the engine compartment of the car.

It is still a further object of the invention to provide a piercing nozzle that is rugged, durable and can be reused by re-sharpening the piercing nozzle when it becomes dull.

It is a further object of the present invention to provide a nozzle that is easy and convenient to use. It can be quickly deployed and used during firefighting operations.

It is another object of the present invention to provide a fire-fighting tool that will be maintained in a position while left unattended.

In a first embodiment, the water hammer comprises a hollow handle having a threaded nipple or other means for connecting the water hammer with a water hose. A center pipe is connected to an opposite end of the hollow hammer. A hammer end is attached to one end of the center pipe. A pyramid-shaped piercing nozzle is attached to an end of the center pipe opposite the hammer end. The piercing nozzle includes a plurality of perforations.

In a second embodiment, the water hammer comprises a solid handle connected to the center pipe. A threaded nipple or other means for connecting the water hammer with the water hose is attached to an end of the center pipe. A pyramid-shaped piercing nozzle attaches at an opposite end of the center pipe opposite the threaded nipple.

### BRIEF DESCRIPTION OF THE DRAWINGS

FIG. 1 is an elevation of a first embodiment of the invention.

FIG. 2 is an elevation of a second embodiment of the invention.

### DETAILED DESCRIPTION OF THE INVENTION

The following is the preferred embodiment or best mode for carrying out the invention. It should be noted that this invention is not limited by the discussion of the preferred embodiment. Certain modifications may be made to the invention without deviating from the spirit and scope of the invention.

The water hammer is used by swinging it in an axe-like manner to drive the piercing fog nozzle into and through a fire barrier. If the water hammer is equipped with a hammer end, a sledgehammer, single-bit axe or other similar tool may be used to aid in driving the piercing water nozzle through the fire barrier. After the piercing water nozzle is driven through the fire barrier, the handle is rotated approximately one-quarter turn or preferably 60 degrees. By rotating the handle, the water hammer will be kept in a fixed position while unattended. Otherwise, the fire fighters must maintain constant pressure against the water hammer to prevent it from being ejected rearwardly from the fire barrier by the pressurized water. Thus, the present invention includes a method of operating the water hammer.

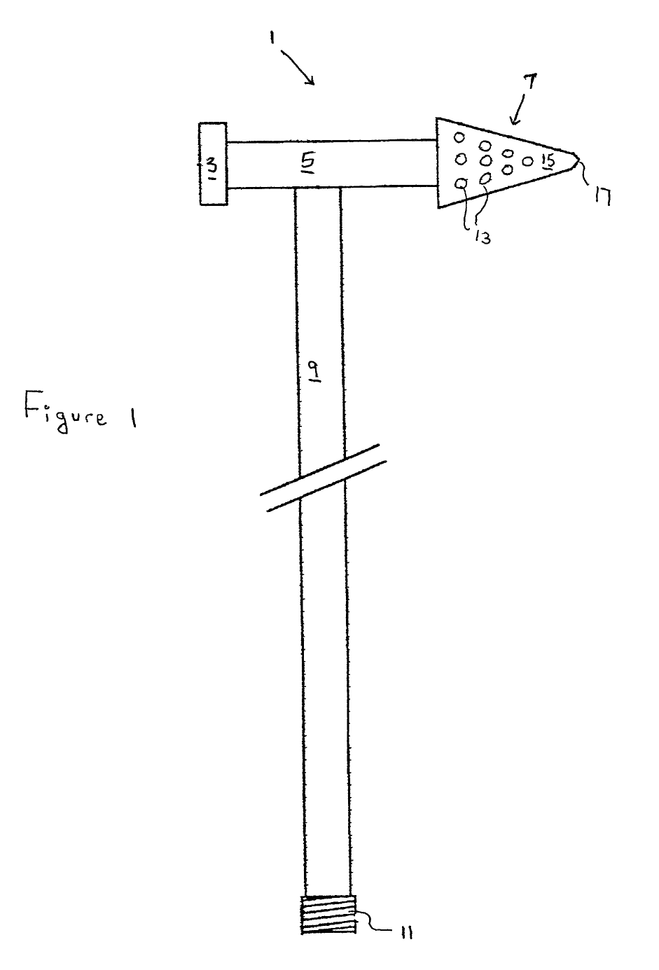

FIG. 1 depicts the water hammer 1. The water hammer 1 comprises a hollow handle 9. The handle 9 typically comprises stainless steel pipe or other heavy duty, durable metal or composite material. Stainless steel is well suited for this application since it resists rusts and is very rugged.

An end of the handle 9 includes a threaded adapter 11 for accepting a complementary female-threaded end of a fire hose. It should be noted that while FIG. 1 depicts the threaded adapter 11 as being a male-type, threaded adapter 11 may include a universal adapter or it may be of a female-type.

A cross-member or center pipe 5 is affixed to an end of handle 9 opposite the threaded connector 11. In the preferred embodiment, handle 9 is welded to center pipe 5 in an essentially perpendicular relationship. The center pipe 5 is also hollow and may be manufactured with the same material as handle 9. The length of the center pipe 5 may vary for different types of applications. For example, the length of the center pipe 5 for a water hammer 1 being used to extinguish automobile fires may be shorter than that of a water hammer 1 that is used to fight fires in an office or residential building.

A battering or hammer end 3 is affixed to an end of center pipe 5. In the preferred embodiment, the diameter of the hammer end is larger that the diameter of the center pipe. The hammer end 3 may be used in the same manner as a sledge hammer. Since the hammer 1 is generally shaped like a sledgehammer, it may function in a like manner. For example, the hammer end 3 of water hammer 1 may be used to knock down doors, destroy concrete obstructions or punch holes in block walls. Thus, the water hammer 3 advantageously may double as a sledgehammer.

A piercing fog nozzle 7 is affixed at an end of the center pipe 5 opposite the hammer end 3. The hollow center of the center pipe directs water, or other fire fighting materials, from the handle towards the piercing fog nozzle 7. It should be noted that the end of the center pipe 5 near the hammer end 3, may be solid or blocked to provide a heavier and more durable end for hammering or battering purposes.

In the preferred embodiment, the piercing fog nozzle 7 comprises a pyramid-shaped material having perforations 13 therein. The piercing fog nozzle 7 comprises three faces 15 that intersect to provide a sharp pyramid tip 17. The tip 17 advantageously focuses forces into a small area when driving the piercing fog nozzle 7 through a fire barrier.

In the preferred embodiment, the piercing fog nozzle 7 is welded to the center pipe 5. However, it is to be realized that the piercing fog nozzle 7 may be affixed or attached to the center pipe 5 through various means or methods. For example, it may comprise a threaded portion that may be mated with a complementary threaded portion of the center pipe 5.

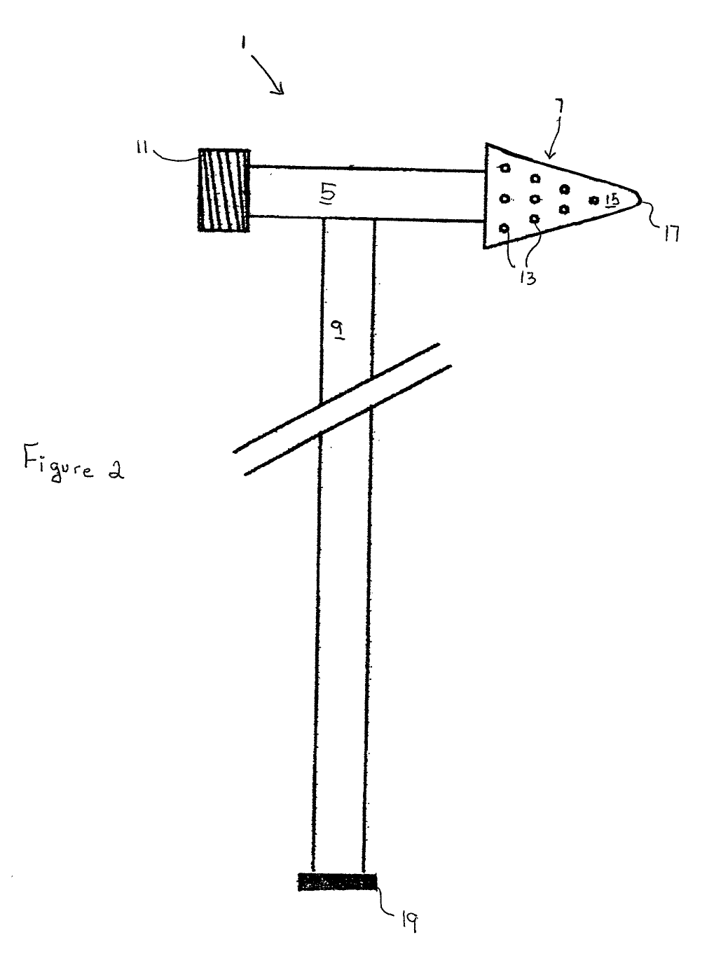

FIG. 2 depicts a second embodiment of the invention. In FIG. 2, the threaded adapter 11 is affixed to an end of the center pipe 5. The piercing nozzle 7 is attached at an end of the center pipe 5 opposite the threaded adapter 11. A stop 19 is provided at an end of handle 9. In this embodiment, the water hammer 1 does not include a hammer end. Thus, the fire fighter must swing the water hammer 1 in an axe-like manner to penetrate a fire barrier.

It is to be understood that the invention is not limited to the exact construction illustrated and described above. Various changes and modifications may be made without departing from the spirit and the scope of the invention as defined in the following claims.

I claim:

1. A water hammer comprising:
a handle;
a hollow center pipe affixed to said handle;
a piercing nozzle affixed at an end of said hollow center pipe.

2. The water hammer of claim 1 further comprising:
an adapter affixed to an end of said handle for coupling the handle to a hose.

3. The water hammer of claim 1 further comprising:
an adapter affixed to an end of said hollow center pipe for coupling the hollow center pipe to a hose.

4. The water hammer of claim 1 wherein said piercing nozzle is pyramid-shaped and having three faces.

5. The water hammer of claim 4 wherein said pyramid-shaped piercing nozzle includes a plurality of holes in at least one face of the piercing nozzle.

6. The water hammer of claim 1 further comprising a stop affixed at an end of the handle opposite the hollow center pipe.

7. A water hammer comprising:
a hollow handle having an adapter for coupling said handle to a hose;
a hollow center pipe affixed to said handle at an end opposite said adapter;
a piercing nozzle affixed at an end of said center pipe;
wherein said hollow center pipe comprises a hammer end located at an end of said hollow center pipe opposite said piercing nozzle.

8. The water hammer of claim 7 wherein said piercing nozzle is pyramid-shaped and having three faces.

9. The water hammer of claim 8 wherein said pyramid-shaped piercing nozzle includes a plurality of holes in at least one face of the piercing nozzle.

10. A water hammer comprising:
a hollow handle;
a center pipe affixed to said handle at one end thereof;
a piercing nozzle affixed to an end of said center pipe.

11. The water hammer of claim 10 further comprising:
an adapter affixed at an end of said hollow handle opposite said center pipe and for coupling said hollow handle to a hose.

12. The water hammer of claim 10 further comprising a hammer end affixed to an end of said center pipe opposite the piercing nozzle.

13. The water hammer of claim 10 wherein said piercing nozzle is pyramid-shaped and having three faces.

14. The water hammer of claim 13 wherein at least one of said three faces includes a plurality of holes for transmitting fire extinguishing materials onto a fire.

15. A water hammer comprising:
a hollow handle having an adapter for coupling a hose to said hollow handle;
a hollow center pipe affixed at an end of said hollow handle opposite said adapter;
a hammer end affixed at an end of said center pipe;
a pyramid-shaped piercing nozzle affixed to an end of said center pipe opposite said hammer end.

16. The water hammer of claim 15 wherein said pyramid-shaped piercing nozzle comprises three faces.

17. The water hammer of claim 16 wherein at least one of said faces includes perforations for transmitting fire-extinguishing materials onto a fire.
